(19) United States
(12) Patent Application Publication
(10) Pub. No.: US 2009/0240671 A1
(43) Pub. Date: Sep. 24, 2009

(54) ELECTRONIC BIBLE

(76) Inventors: Guillermo Torres, Oceanside, CA (US); Heidy Torres, Oceanside, CA (US)

Correspondence Address: NW-IP-LAW, 6039 E. Grant RD., Tucson, AZ, 85712, US

(21) Appl. No.: 12/053,035

(22) Filed: Mar. 21, 2008

(51) Int. Cl. G06F 17/30

(52) U.S. Cl. 707/4

(57) ABSTRACT

A portable electronic bible including a user interface and a display screen wherein a first side of the display screen provides primary biblical information (e.g., text), while a second side of the display screen displays secondary biblical information (e.g., dictionary/thesaurus data, currency exchange) related to the primary biblical information displayed on the first side, and commentary files. The portable electronic bible includes a database for primary information and a database for secondary information. The secondary biblical information includes dictionary terms and/or thesaurus information about terms or persons referred to in the primary biblical information, e.g., such as the dictionary meaning of certain Christian words shown in the biblical text, as well as data for the calculation of currency conversion between modern currency unit and the currency unit in the Bible era. The portable electronic bible also includes a central processing and internal storage unit to support user commentary file creation and storage, as well as search on and retrieval of existing commentary files.

### FIELD OF THE INVENTION

The present invention is directed to an electronic bible, and more particularly to an electronic bible that can simultaneously display biblical text, provide study tools including user commentary tool, electronic dictionary/thesaurus for Biblical terms, currency exchange calculator to compare modern currency to ancient currency concurrent to the Bible era. User commentary files can be indexed and retrieved by search using keywords chosen by the user, date/time stamp of the commentary file, or the verse number and the book title/chapter of the subject matter being commented.

### BACKGROUND OF THE INVENTION

Electronic media has long been provided on electronic devices. For example, electronic books can be read over a laptop computer or personal digital assistant. Personal digital assistance are widely used and known to provide various functions such as email, Internet access, messaging (E.g., SMS—Short Messaging Service), address book management, calculator functions and various games (e.g., solitaire). For example, the global company Research in Motion (RIM) sells a well-known, widely used personal digital assistant referred to as a “BlackBerry®”.

Electronic bibles are also generally known. For example, published United States Patent Application US 200310006969A1 by Barras entitled “System for One-Touch Bible Book Selection and Viewing” describes such a device. Although general bible text and information can be singularly provided through a device like Barras's, a user cannot easily refer to a secondary source for definitions or supplementary information for what is being read in the main text of the electronic bible information, which is typically only the text renderings directly from the bible.

What is needed is an electronic bible that can enable a user to read primary biblical text and simultaneously refer to a secondary database of information related to the primary biblical text, such as dictionary definitions or a thesaurus for Christian terms or names in the text. The present invention provides such an system.

### SUMMARY OF THE INVENTION

It is a feature of the present invention to provide an electronic bible including a user interface and a display screen wherein a first side of the display screen provides primary biblical information (e.g., text), while a second side of the display screen displays secondary biblical information (e.g., dictionary/thesaurus data) as well as user comments related to the primary biblical information displayed on the first side.

It is another feature of the present invention that the electronic bible includes databases for primary information (e.g., the Bible text) and secondary biblical information (e.g., dictionary/thesaurus data and currency exchange data). It is another feature of the present invention that the electronic bible includes a central processing and internal storage unit that can support the proper operation of the present invention. The central processing unit, with the appropriate software implementation that resides in the internal storage unit, can provide functions including to the followings, but not limit to: word processing for user commentary, database search to retrieve the information sought by the users, coordination of data flow between the central processing unit and the peripheral devices such as the displays and the input keypads. The user generated commentary files can be stored in the internal storage unit. These files can be searched and retrieved by the users by using the keywords, date/time stamps, or the verse number, book chapter and book title of the subject matter being commented.

It is yet another features of the present invention that the secondary biblical information includes currency exchange data, and dictionary terms and/or thesaurus information about terms or persons referred to in the primary biblical information, e.g., such as the dictionary meaning of certain Christian words shown in the biblical text.

It is another feature of the present invention that the electronic bible be a portable electronic bible.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 illustrates a front view of an electronic bible in accordance with features of the present invention;

FIG. 2 illustrates a block diagram of system components included in the electronic bible shown in FIG. 1;

FIG. 3 illustrates a block diagram of databases included in the electronic bible shown in FIGS. 1 and 2;

FIG. 4 illustrates a flow diagram of steps for using the electronic bible described with respect to FIGS. 1-3; and

FIG. 5 illustrates a flow diagram of system components and their operation to enable use of electronic bible functions.

### DESCRIPTION OF PREFERRED EMBODIMENTS

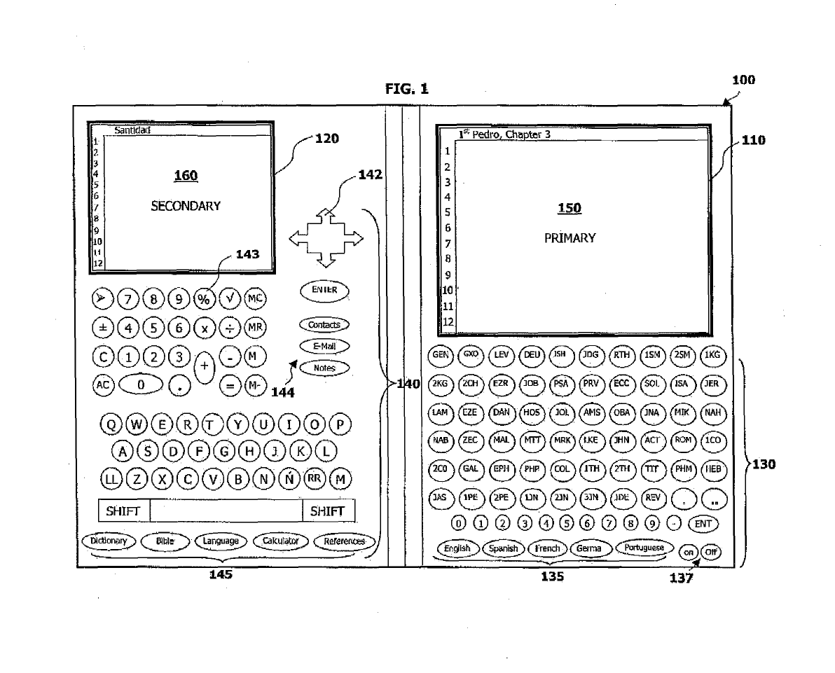

Referring now to FIG. 1, an electronic bible 100 including a first display screen 110, a second display screen 120, and respective user interfaces 130, 140 is illustrated. Although the electronic bible 100 is shown as a portable device, it can be appreciated after reading this disclosure that features of the present invention can also be implemented in a desktop computer system; therefore reference to portable herein should not be construed as a limitation over the present invention.

The display screens 110, 120 are adapted to display primary and secondary bible-related information 150, 160, respectively. Primary information will typically comprise of text taken directly from Chapters or Books of a bible which are generally shown abbreviated in the button of user interface 130. Secondary information 160 can include information provided from a dictionary or thesaurus in association with data taken from the primary information 150 display at the first screen 110. Secondary information 160 can also include data for currency conversion between the modern currency unit and currency unit adopted during the Bible era.

With respect to the user interfaces 130, 140, one skilled in the art can readily appreciate some of the functions illustrated in FIG. 1. Self explanatory to one skilled in the art (which can be the routine user of a PDA, such as a BlackBerry® device), will understand that the mouse 142 enables movement of a cursor on a screen, similar to the mouse and cursor on desktop computers. The “Enter” botton operates in association with the mouse 142 to enable selection of data from rather screen 110, 120. The calculator buttons 143 enable basic calculator functionality and can also enable currency conversion (e.g., such as old currency described in chapters of the bible, to modern currency such as the US dollar). The bottom most buttons associated with user interface 130 enable the selection of “Dictionary”, “Bible”, “Language”, “Calculator” and “References” functions for the user.

With respect to user interface 130, the skilled in the art would again realize that the majority of round buttons illustrated are abbreviations of bible chapters. A user can select a button associated with a bible chapter and enter the selection with the “enter” button, or the user can type in a code or chapter number and enter it. Language buttons 135 are self explanatory and as shown enable the user to select from the following language for the electronic bible to operate with: “English”, “Spanish”, “French”, German” and “Portuguese”. The On/OFF button 137 are self explanatory and require little detailed explanation other than is can be appreciated that the power buttons 137 can control both sides of the electronic bible.

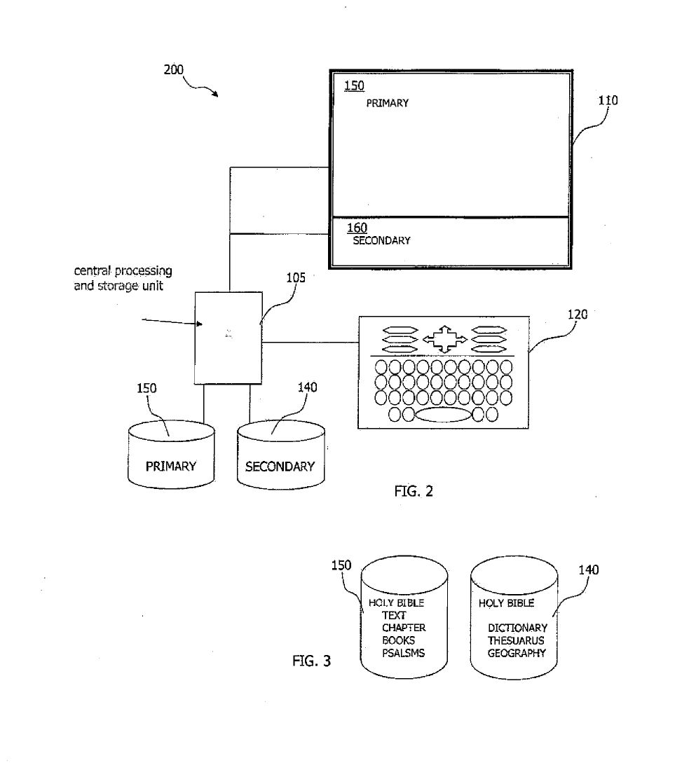

Referring to FIG. 2, a block diagram 200 of system components for the portable electronic bible is illustrated in accordance with features of the present invention. A central processing unit 105, user interface 120 and display screen 110 are standard features of a portable device. A primary database 130 for storing biblical text and a secondary database 140 for storing secondary bible-related information (e.g., dictionary or thesaurus information and currency data) are key features of the present invention together with unique processing by the central processing and storage unit 105 to simultaneously process user requests associated to biblical text and simultaneously display secondary information on a second section 160 of the display screen together with primary bible information displayed on a first section 150 of the display screen. The central processing and storage unit 105 will also support word processing function necessary to generate user commentaries to the biblical text being studied, storage of such commentary files, and search and retrieval of such commentary files. Retrieval method will include retrieval by keywords, by date/time stamps of the files, or by the Book title, chapter, and/or verse number.

Referring to FIG. 3, illustrated is a block diagram 300 of databases used for storing primary and secondary bible information in the portable electronic bible described in FIGS. 1 and 2. The primary database 130 includes complete biblical text (e.g., Books or Chapters) of a holy bible. The primary information is rendered directly on the first section 150 of the display screen 110. It can be appreciated that the text displayed on the display screen can be highlighted and searched within the secondary database 140 to find dictionary 145 and thesaurus 147 information stored therein. Once found, the secondary information can be rendered on the second section 160 of the display screen 110.

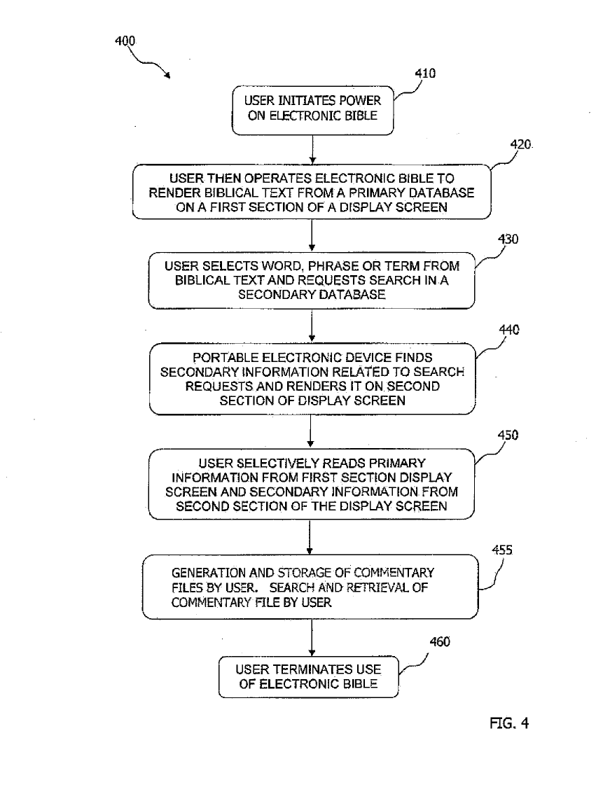

Referring to FIG. 4, illustrated is a flow diagram 400 of steps for using the electronic bible described with respect to FIGS. 1-3. A user initiates power on an electronic bible as shown in Block 410. The user then operates a portable electronic bible to render biblical text from a primary database on a first section of a display screen as shown in Block 420. The user selects a word, phrase or term from the biblical text and requests a search in a secondary database as shown in Block 430. A portable electronic device finds secondary information related to the search requests and renders it on a second section of the display screen as shown in Block 440. The user selectively reads primary information from the first section display screen and secondary information form the second section of the display screen as shown in Block 450. The user can create and save his/her commentary on the Bible verses being studied by using the user interface as shown in Block 455. The user can also search for particular commentary files as shown in Block 455. The user then terminates use of the electronic bible as shown in Block 460.

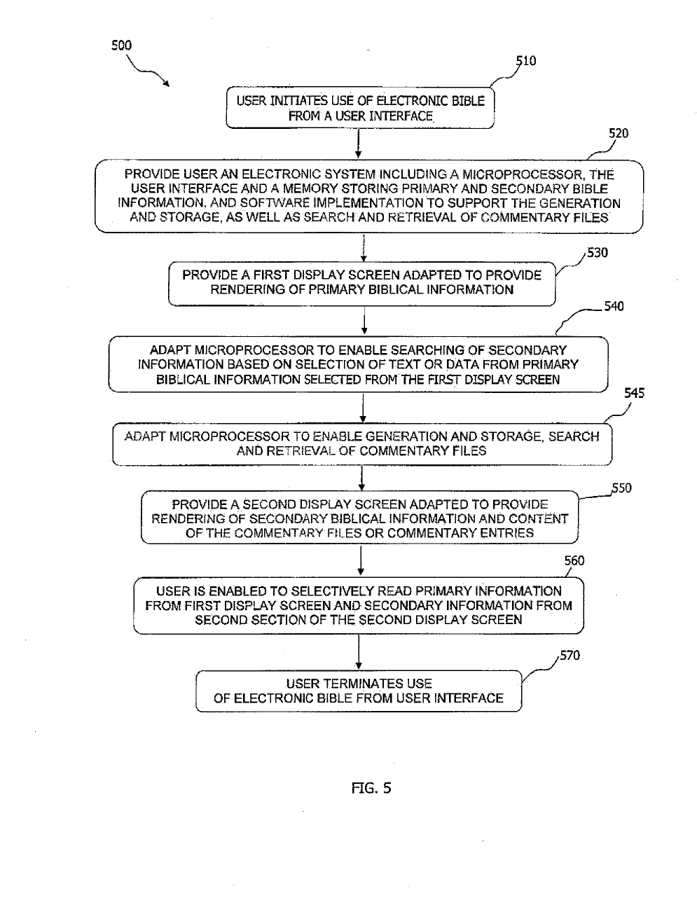

Referring to FIG. 5, a flow diagram 500 illustrating how system components operate together to enable use of the electronic bible is provided. A user initiates use of an electronic bible from a user interface as shown in Block 510. Shown in Block 520 is an electronic system including a central processing and storage unit, and an user interface. The internal storage unit will store databases for the primary and the secondary bible information, the commentary files, and other supportive software for the proper functioning of the present invention. As shown in Block 530, a first display screen adapted to provide a rendering of primary biblical information is provided. As shown in Block 540, the central processing unit is adapted to enable searching of secondary information based on selection of text from the primary information selected from the first display screen. As shown in Block 545, the central processing unit is adapted to enable generation and storage, search and retrieval of commentary files. As shown in Block 550, a second display screen adapted to provide a rendering of secondary biblical information, and content of the commentary files and/or commentary entries is provided. Then as shown in Block 560, a user is enabled to selectively read primary information from the first display screen and secondary information from the second display screen. Then as shown in Block 570, the user can terminate use of the electronic bible from the user interface.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A portable electronic bible comprising:
user interface;
a display screen further comprising a first section to provide a rendering of primary biblical information and a second section to provide a rendering of secondary biblical information;
a database for storing primary biblical information;
a database for storing secondary biblical information; and
a central processing unit enabling searching of secondary information based on selection of text from the primary biblical information, generation and storage of commentary files, and search and retrieval of commentary files residing in the internal memory unit.

2. The portable electronic bible of claim 1, wherein the secondary biblical information includes dictionary terms and/or thesaurus information about terms or persons referred to in the primary biblical information, as well as currency exchange calculation facility.
